(19) United States
(12) Patent Application Publication
(10) Pub. No.: US 2010/0047482 A1
(43) Pub. Date: Feb. 25, 2010

(54) PHOTO-REACTIVE COMPOUNDS AND LIQUID CRYSTAL DISPLAY DEVICE USING THE SAME

(75) Inventors: Hoi-Lim KIM, Eujeongbu-si (KR); Jun-Woo LEE, Anyang-si (KR); Hyun-ku AHN, Hwanseong-si (KR); Baek-Kyun JEON, Yongin-si (KR); Tae-Sung JUNG, Suwon-si (KR); Jeong-Hye CHOI, Incheon-si (KR); Sung-Yi KIM, Gwangju-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/464,455

(22) Filed: May 12, 2009

(30) Foreign Application Priority Data
Aug. 21, 2008 (KR) 10-2008-0081720

(51) Int. Cl. G02F 1/1337; C08G 63/00; C08G 69/02

(52) U.S. Cl. 428/1.2; 528/271; 528/330

(57) ABSTRACT

The present invention provides photo-reactive compound. The photo-reactive compound, in which chains are combined to a polymer backbone that is used for a photo-alignment layer compound, is represented by the following Formula 1 or Formula 2.

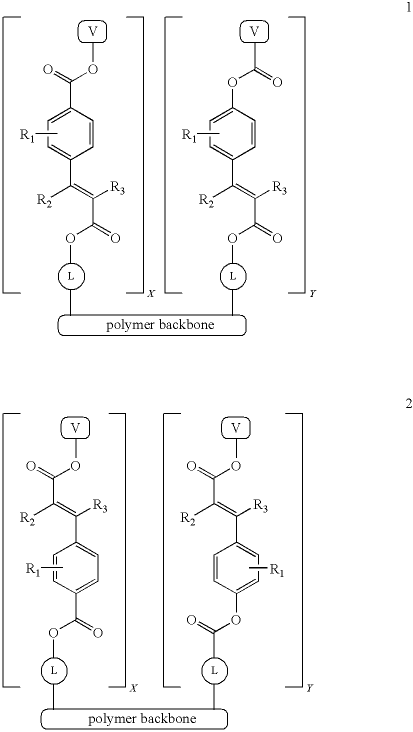

L denotes a substituted or unsubstituted alkyl group having at least 1 but no more than 18 carbons, V denotes a substituted or unsubstituted alkyl group having at least 1 but no more than 18 carbons, R₁, R₂, and R₃ each denote H or a substituted or unsubstituted alkyl group having at least 1 but no more than 18 carbons, X+Y=1, 0<X, and Y<1.

### CROSS-REFERENCE TO RELATED APPLICATION

This application claims priority from and the benefit of Korean Patent Application No. 10-2008-0081720, filed on Aug. 21, 2008, which is hereby incorporated by reference for all purposes as if fully set forth herein.

### BACKGROUND OF THE INVENTION

1. Field of the Invention

The present invention relates to a cinnamate-based photo-reactive compound, and a liquid crystal display device using a photo-alignment layer including the photo-reactive compound.

2. Discussion of the Background

For image realization of a liquid crystal device, the liquid crystal should be aligned in a constant direction at an interface between the liquid crystal and the transparent conductive glass electrodes. Uniformity of the liquid crystal alignment is a very important factor in determining image quality of a liquid crystal display.

A conventional liquid crystal alignment method includes a rubbing step in which a polymer film, which may include polyimide, is coated over a substrate, which may include glass, and a surface of the substrate is rubbed with fiber, which may include polyester, in a uniform direction. However, the rubbing step may generate fine dust or electrostatic discharge (ESD) due to friction between the fiber and the polymer film that may cause a serious problem in manufacturing of the liquid crystal panel.

Recently, a photo-alignment method in which anisotropy is induced to the polymer layer through light radiation to align the liquid crystal has been researched in order to solve the above problem. Polymers that contain a photo-functional group such as azobenzene, cumarine, chalcone, or cinnamate may be used as a material in the photo-alignment method, and these polymers react to polarized light radiation so that photo-isomerizaton or photo-crosslinking may be aeolotropically generated, and accordingly aeolotropy may be generated on a polymer surface and liquid crystals may be aligned in one direction.

### SUMMARY OF THE INVENTION

The present invention provides a cinnamate-based photo-reactive compound that may attenuate an afterimage and a liquid crystal display (LCD) device including the same.

Additional features of the invention will be set forth in the description which follows, and in part will be apparent from the description, or may be learned by practice of the invention.

An embodiment of the present invention discloses a photo-reactive compound in which chains are combined to a polymer backbone used for a photo-alignment layer compound. The photo-reactive compound is represented by the following Formula 1 or Formula 2:

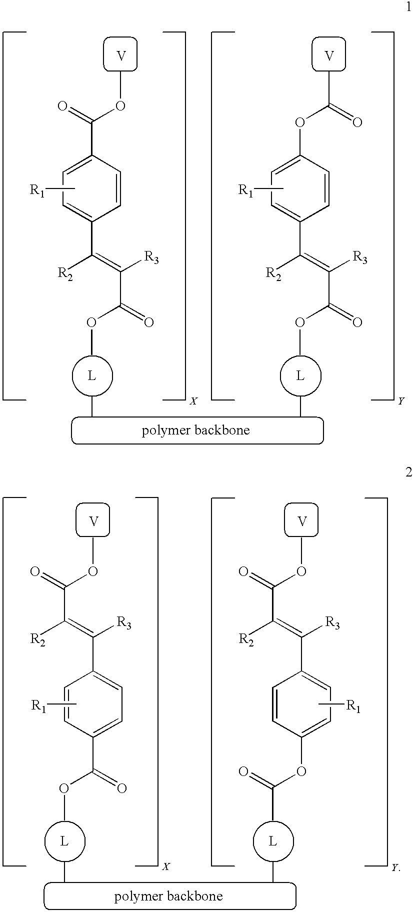

L denotes a substituted or unsubstituted alkyl group having at least 1 but no more than 18 carbons, V denotes a substituted or unsubstituted alkyl group having at least 1 but no more than 18 carbons, R₁, R₂, and R₃ each denote H or a substituted or unsubstituted alkyl group having at least 1 but no more than 18 carbons, X+Y=1, 0<X, and Y<1.

An embodiment of the present invention also discloses an LCD device including a lower substrate, a thin film transistor disposed on the lower substrate, a pixel electrode connected to the thin film transistor, an upper substrate facing the lower substrate, a color filter disposed on the upper substrate, a color filter disposed on the upper substrate, a common electrode arranged to face the pixel electrode on the color filter, a liquid crystal layer disposed between the lower substrate and the upper substrate, and a photo-alignment layer supporting the liquid crystal layer. The photo-alignment layer includes a photo-reactive compound according to Formula 1 or Formula 2.

An embodiment of the present invention also discloses a method for manufacturing an LCD device including manufacturing a liquid crystal alignment solution by dissolving the photo-reactive compound of one of Formula 1 or Formula 2 in an organic solvent, coating the liquid crystal alignment solution over a substrate and removing the solvent, and light-radiating a surface of the solvent-removed substrate.

An embodiment of the present invention also discloses a photo-reactive compound manufacturing method including generating a Compound b through the following Reaction Equation M, generating a Compound d through the following Reaction Equation N, dissolving Compound b and Compound d in an organic solvent, and mixing dianhydride into the mixed organic solvent.

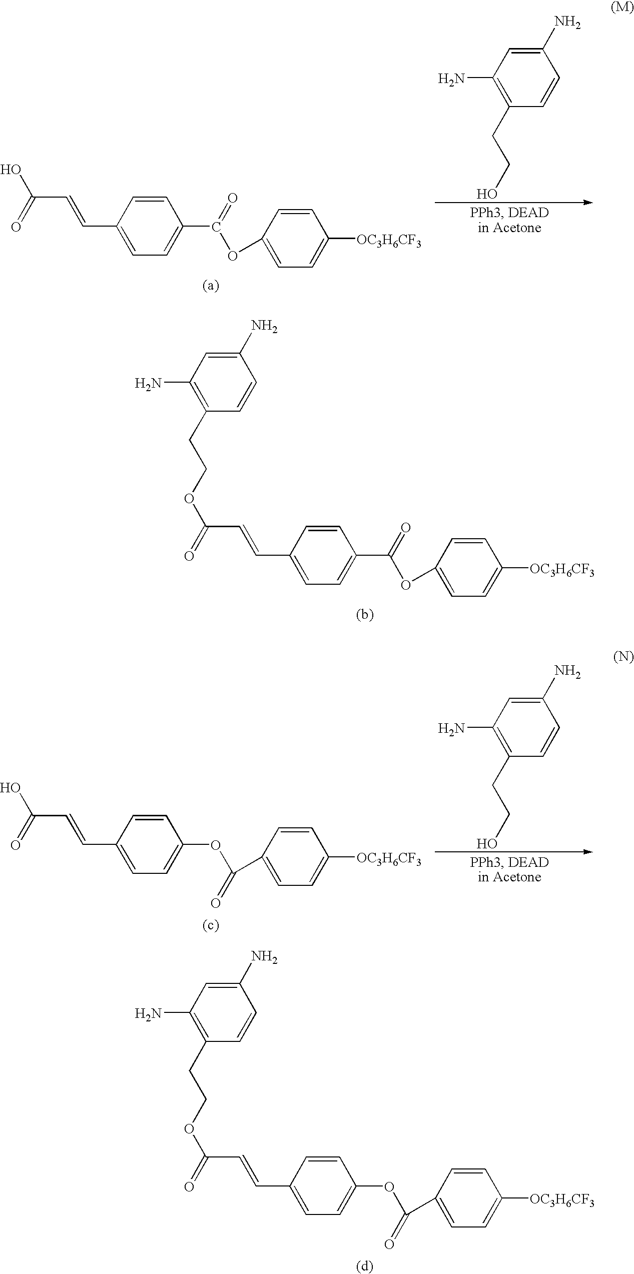

PPh₃ denotes triphenylphosphine and DEAD denotes diethyl azodicarboxylate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a photo of an afterimage pattern of a liquid crystal display device, which includes a photo-alignment layer according to an exemplary embodiment of the present invention, at a voltage of 2.0 V.

FIG. 2 is a graph of voltage data that shows a luminance difference of a liquid crystal display device that includes a photo-alignment layer according to an exemplary embodiment of the present invention.

FIG. 3 is a photo of an afterimage of a liquid crystal display device, which includes a photo-alignment layer according to an exemplary embodiment of the present invention, in a non-electric field.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

A cinnamate-based photo-alignment layer may be polarized in one direction due to a delocalized π electron as shown in the following Formula (A). In the Formula (A), the arrow indicates the polarization direction.

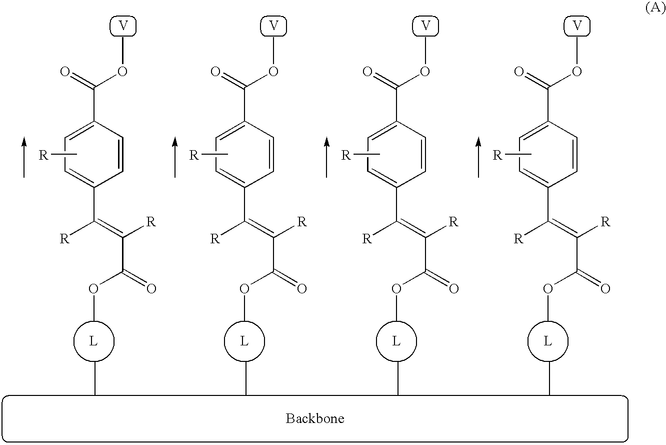

In the case of the Formula (A), the entire surface of the alignment layer may be very polarized so that an afterimage may be more serious.

To the contrary, in the exemplary embodiment of the present invention, the polarization of the photo-alignment layer may be reduced by introducing a polarization mixing structure as shown in the following Formula (B). The arrow in Formula (B) indicates the polarization direction.

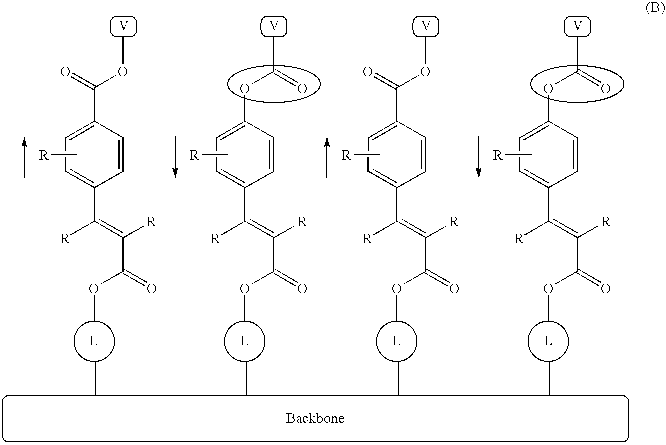

An embodiment of the present invention discloses a photo-reactive compound in which chains are combined to a polymer backbone used for a photo-alignment layer compound. The photo-reactive compound is represented by the following Formula 1 or Formula 2:

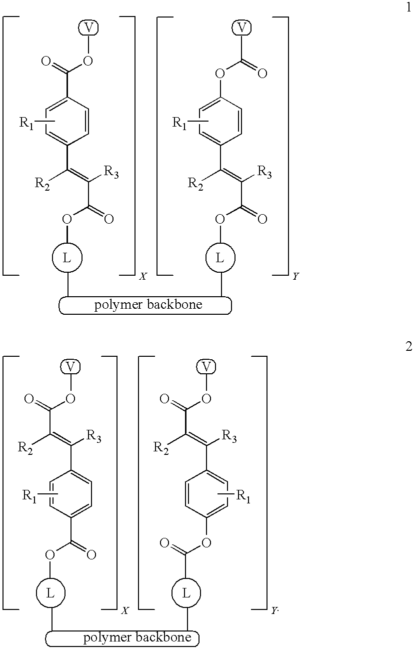

L denotes a substituted or unsubstituted alkyl group having at least 1 but no more than 18 carbons, V denotes a substituted or unsubstituted alkyl group having at least 1 but no more than 18 carbons, R₁, R₂, and R₃ each denote H or a substituted or unsubstituted alkyl group having at least 1 but no more than 18 carbons, X+Y=1, 0<X, and Y<1.

Y may be within a range of 0.3≦Y≦0.7.

X:Y may be 1:1.

At least one carbon in L may be substituted with one selected from a group consisting of O, C═O, O(C═O), benzene, a benzene derivative, cyclohexane, and a cyclohexane derivative.

At least one carbon in V may be substituted with one selected from a group consisting of O, C═O, O(C═O), benzene, a benzene derivative, cyclohexane, and a cyclohekane derivative.

Each of R₁, R₂, and R₃ may comprise at least one carbon that is substituted with one selected from a group consisting of O, C═O, O(C═O), benzene, a benzene derivative, cyclohexane, and a cyclohexane derivative.

The polymer backbone of Formula 1 or Formula 2 may be selected from a group consisting of polyimide, a polyimide derivative, polyacrylate, a polyacrylate-based group, polymethylmethacrylate, a polymethylmethacrylate derivative, polystyrene, a polystyrene derivative, polyvinylalcohol, and a polyvinylalcohol derivative.

A hydrogen of one of L, V, R₁, R₂, and R₃ may be substituted with F or Cl. Formula 1 is represented by the following Formula 3 and Formula 2 is represented by the following Formula 4:

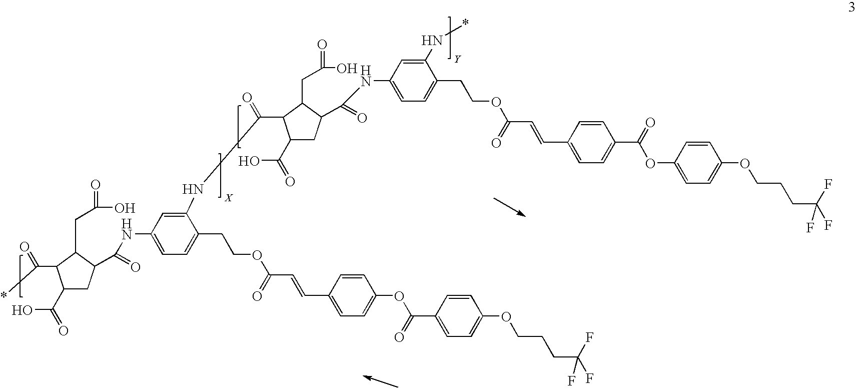

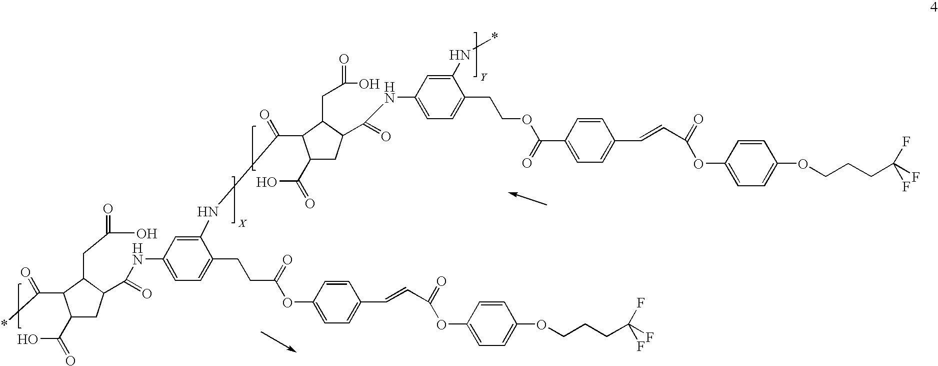

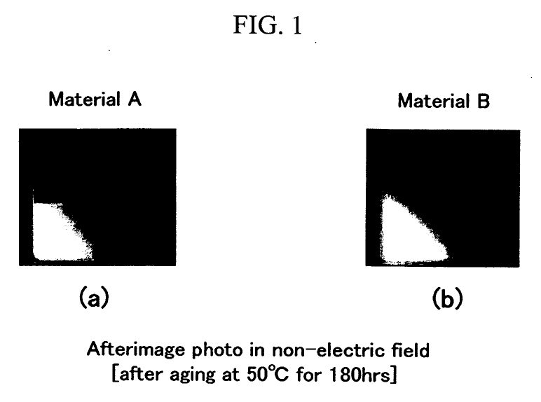

FIG. 1 is a photo of afterimage patterns at a voltage of 2.0V (a) in a liquid crystal display (LCD) device, which includes a photo-alignment layer according to a comparative example, and (b) in an LCD device, which includes a photo-alignment layer according to an exemplary embodiment of the present invention.

### Exemplary Embodiment

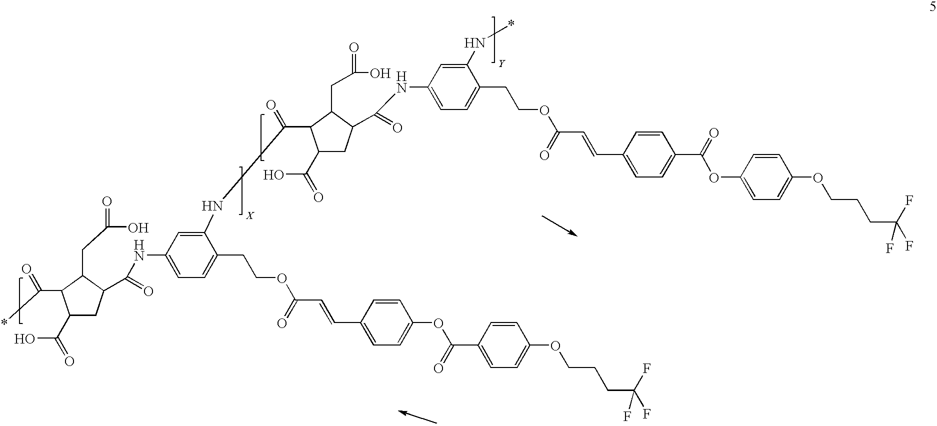

Coating is performed on a 17-inch panel, a pre-bake process is performed at about 70° C., and a main-cure process is performed at about 200° C. for 10 minutes using the material of Formula 5. Then vertically polarized UV light is radiated with an intensity of 1 J/cm² at an angle of about 40 degrees on a substrate using a UV light exposer made by the USHIO company, such that a liquid crystal panel is manufactured. In this case, a direction that is perpendicular to the substrate is 0 degrees. Liquid crystal used therein is vertically aligned (VA) liquid crystal made by Merck company.

A pre-tilt angle of the liquid crystal molecules is 89.0 degrees, and tilt alignment (slightly tilted alignment) occurs due to UV radiation so that a spotless panel of good quality may be manufactured. Response speed was 8.0 ms, transmittance was very high, and the contrast ratio (CR) was 2250.

As shown in FIG. 1(b), a black afterimage and a surface afterimage were evaluated after applying a 2.0 V voltage and maintaining the LCD device at 50° C. for 180 hours, and a result of the evaluation shows that the afterimages were attenuated.

### Comparative Example

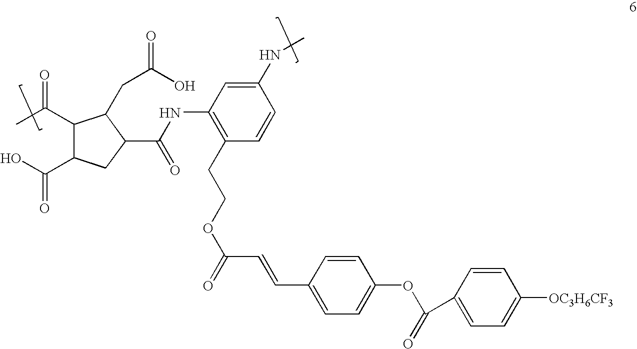

Coating is performed on a 17-inch panel, a pre-bake process is performed at about 70° C., and a main-cure process is performed at about 200° C. for 10 minutes using the material of Formula 6, and then vertically polarized UV light is radiated with an intensity of 1 J/cm² at an angle of about 40 degrees on a substrate using a UV light exposer made by the USHIO company such that a liquid crystal panel is manufactured. In this case, a direction that is perpendicular to the substrate is 0 degrees. Liquid crystal used therein was VA liquid crystal made by Merck company.

A pre-tilt angle of the liquid crystal molecules is 89.0 degrees, and tilt alignment (slightly tilted alignment) occurs due to UV radiation so that a spotless panel of good quality may be manufactured. However, as shown in FIG. 1(a), a surface afterimage was evaluated after applying a 2.0 V voltage and maintaining the LCD device at 50° C. for 180 hours, and a result of the evaluation shows that the afterimage is too strong so the voltage applied thereto had to be increased to 4.4 V in order to eliminate the afterimage.

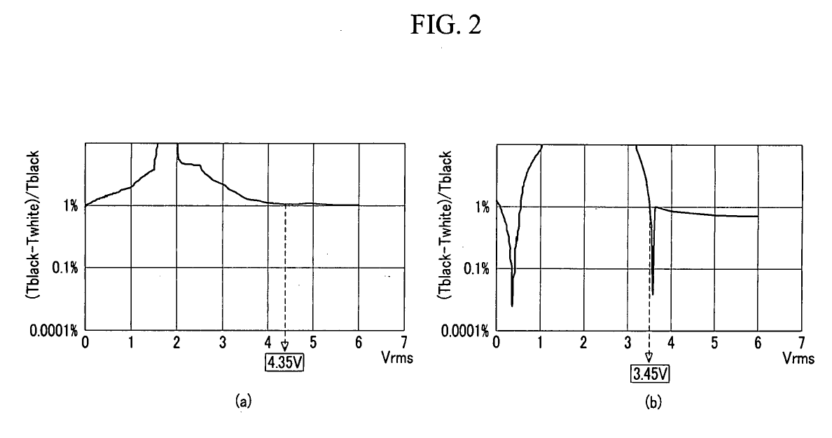

FIG. 2(a) shows a voltage-luminance difference measured while applying the same voltage to two parts of an LCD device, which includes an photo-alignment layer made of a material of Formula 6, after maintaining one of the two parts as black and the other as white. FIG. 2(b) shows a voltage-luminance difference measured while applying the same voltage to two parts of an LCD device, which includes a photo-alignment layer made of a material of Formula 5, after maintaining one of the two parts as black and the other as white.

In the case of FIG. 2(a), a minimum voltage of 4.35 V was required to maintain a luminance difference between the black part and the white part within 1%, and in the case of FIG. 2(b), a minimum voltage of 3.45 V was required to maintain a luminance difference between the black part and the white part within 1%. Through the above cases, the luminance difference between the two parts becomes the same with a lower voltage so the afterimage level may be better attenuated with the material of Formula 5 than with the material of Formula 6.

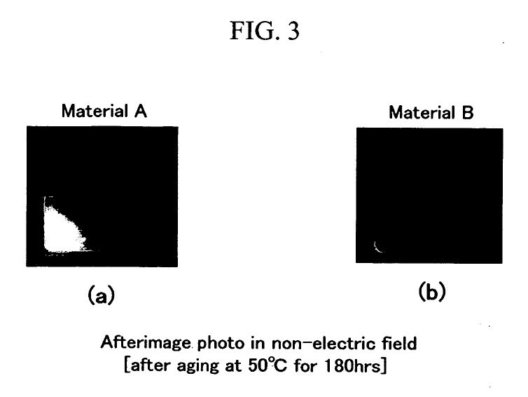

FIG. 3 is a photo of afterimage patterns (a) in an LCD device including a photo-alignment layer according to the comparative example and (b) an LCD device including a photo-alignment layer according to the exemplary embodiment of the present invention after maintaining the LCD devices (a) and (b) at 50° C. for 180 hours without applying an electric field respectively thereto.

The following Equation (C) shows a value representing an afterimage.

[(T_{black}-T_{white})/T_{black}]*100----(C)

T: transmittance

FIG. 3(a) shows an afterimage pattern of an LCD device including the material of Formula 6, and a value of Equation C was measured as 5.13. FIG. 3(b) shows an afterimage pattern of an LCD device including the material of Formula 5, and the value of Equation C was measured as 0.71. Therefore, a measurement result when an electric field was not applied also confirms that the luminance difference between the black part and the white part is almost eliminated so that the afterimage may be remarkably attenuated in the case of the material of Formula 5, that is, the polarization mixing structure.

The photo-alignment layer using the photo-reactive compounds according to the exemplary embodiment of the present invention may be manufactured by dissolving the photo-reactive compounds in a solvent and coating the liquid crystal alignment solution on a substrate, is eliminating the solvent, and performing light-radiation.

The LCD device formed by using the photo-reactive compounds according to the exemplary embodiment of the present invention may include an upper substrate and a lower substrate disposed to face each other, a liquid crystal layer disposed between the upper and lower substrates and sealed therein, a liquid crystal driving device disposed on the lower substrate, a pixel electrode connected to the liquid crystal driving device, a common electrode arranged to face the pixel electrode on the upper substrate, a photo-alignment layer supporting the liquid crystal layer, a polarization filter disposed in each of the upper and lower substrates, and a color filter disposed in the upper substrate. The photo-alignment layer includes a photo-reactive compound according to Formula 1 or Formula 2.

Hereinafter, a photo-reactive compound, a photo-alignment layer using the photo-reactive compound, and a method for manufacturing a LCD device that includes the photo-alignment layer according to an exemplary embodiment of the present invention will be described.

A case in which a polymer backbone is a polyimide will be described.

As the first step, 1.82 g (10 mmol) of (1-hydroxyethyl-1,4-diaminobenzene), 0.1 mmol of triphenylphosphine (PPh3), and 0.1 mmol of diethyl azodicarboxylate (DEAD) are added to 100 mL of acetone and stirred, 8.88 g (10 mmol) of 3-[4-{4-(4-(1,1,1-trifluoro)butanoxyphenyl)carbonyloxy}phenyl]prop-2-enoic acid are dripped therein while stirring, and then a reaction occurs so that 8.8 mmol of 2,2-bis(1,4-diaminophenyl)-1,3-di[3-[4-{4-(4-(1,1,1-trifluoro)butanoxyphenyl)carbonyloxy}phenyl]prop-2-enoyl]propanediol are produced. The reaction is represented by the following Reaction Equation M.

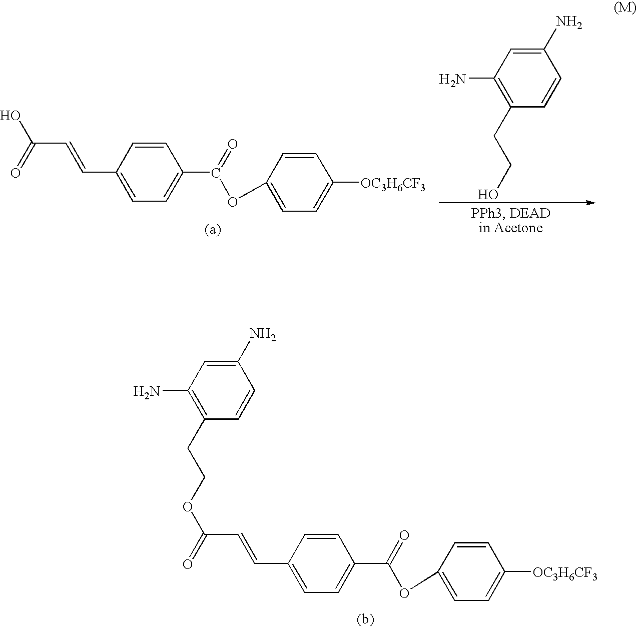

As the second step, 1.82 g (10 mmol) of (1-hydroxyethyl-1,4-diaminobenzene), 0.1 mmol of triphenylphosphine (PPh3), and 0.1 mmol of diethyl azodicarboxylate (DEAD) are added to 100 mL of acetone and (3-[4-{4-(4-(1,1,1-trifluoro)butanoxyphenyl)oxycarbonyl}phenyl]prop-2-enoic acid) are dripped therein and stirred, then a reaction occurs so that 8 mmol of (2,2-bis(1,4-diaminophenyl)-1,3-di[3-[4-{4-(4-(1,1,1-trifluoro)butanoxyphenyl)oxycarbonyl}phenyl]prop-2-enoyl]propanediol) are produced. The reaction is represented by the following Reaction Equation N.

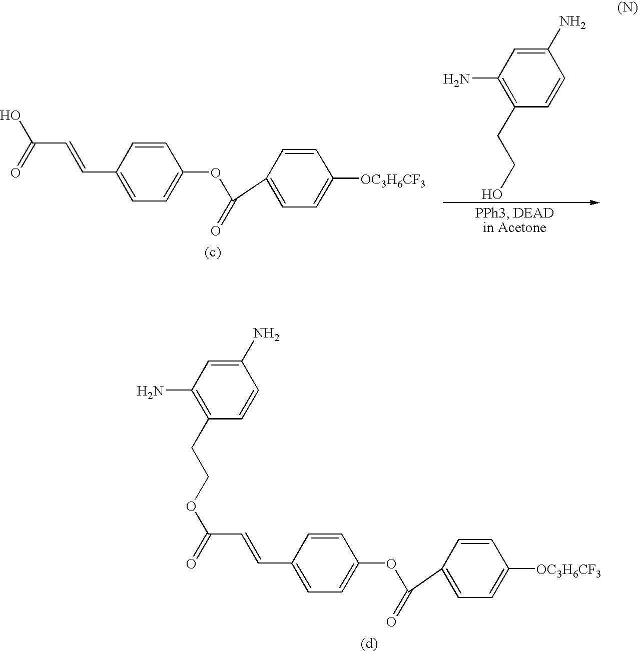

As the third step, 10.34 g of the (2,2-bis(1,4-diaminophenyl)-1,3-di[3-[4-{4-(4-(1,1,1-trifluoro)butanoxyphenyl)carbonyloxy}phenyl]prop-2-enoyl]propanediol) generated in the first step and 10.34 g of (2,2-bis(1,4-diaminophenyl)-1,3-di[3-[4-{4-(4-(1,1,1-trifluoro)butanoxyphenyl)oxycarbonyl}phenyl]prop-2-enoyl]propanediol) generated in the second step are dissolved in solution under an argon atmosphere. Here, the solution is made by mixing N-methylpyrrolidone (NMP) and butyl cellulose (BC) at a mole fraction ratio of 7:3. While maintaining the solution at 0° C., 10 mmol of dianhydride is added to the solution. The temperature is increased from 0° C. to 25° C. while slowly stirring the solution. In this case, the compounding process is stopped when the intrinsic viscosity of the solution becomes 0.20-0.30 dl/g and the solution is frozen. The photo-reactive compound solution made through the above-described process may be used as an undiluted solution of the photo-alignment layer.

The photo-reactive compound solution may be coated on a 17-inch panel, the panel may be pre-baked at 70° C., the pre-baked panel may be main-cured at 100° C. for 10 minutes, and then UV light, which may be perpendicularly polarized at 40 degrees, is radiated to the panel using the UV exposer such that a liquid crystal panel can be manufactured. In this case, a direction that is perpendicular to the surface of the substrate is 0 degrees. The liquid crystal provided in the panel may be VA liquid crystal.

According to another exemplary embodiment of the present invention, polarization of a photo-alignment layer may be reduced using a polarization mixing structure as shown in Formula 7.

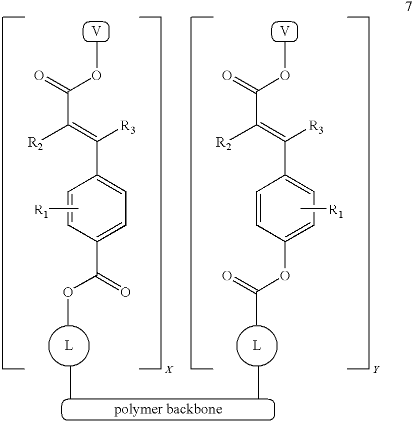

In Formula 7 a carboxyl group that causes polarization is combined with L. Polarization may be offset and an afterimage may be reduced if a photo-alignment layer is manufactured using a material of Formula 7.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A photo-reactive compound in which chains are combined to a polymer backbone, the photo-reactive compound being represented by the following Formula 1 or Formula 2: 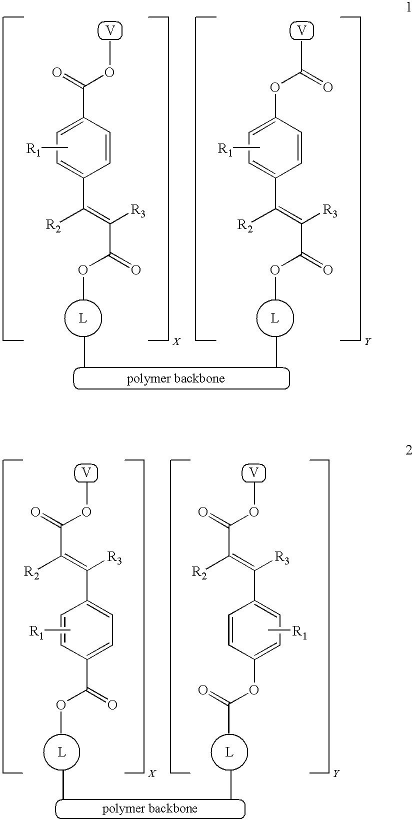
wherein L denotes a substituted or an unsubstituted alkyl group having at least 1 but no more than 18 carbons, V denotes a vertical revelation unit that is a substituted or unsubstituted alkyl group having at least 1 but no more than 18 carbons, R₁, R₂, and R₃ each denote H or a substituted or unsubstituted alkyl group having at least 1 but no more than 18 carbons, X+Y=1, 0<X, and Y<1.

2. The photo-reactive compound of claim 1, wherein Y is within a range of 0.3≦Y≦0.7.

3. The photo-reactive compound of claim 1, wherein X:Y is 1:1.

4. The photo-reactive compound of claim 1, wherein at least one carbon in L is substituted with one selected from a group consisting of O, C═O, O(C═O), benzene, a benzene derivative, cyclohexane, and a cyclohexane derivative.

5. The photo-reactive compound of claim 1, wherein at least one carbon in V is substituted with one selected from A group consisting of O, C═O, O(C═O), benzene, a benzene derivative, cyclohexane, and a cyclohexane derivative.

6. The photo-reactive compound of claim 1, wherein each of R₁, R₂, and R₃ comprises at least one carbon that is substituted with one selected from a group consisting of O, C═O, O(C═O), benzene, a benzene derivative, cyclohexane, and a cyclohexane derivative.

7. The photo-reactive compound of claim 1, wherein the polymer backbone of Formula 1 or Formula 2 is selected from a group consisting of polyimide, a polyimide derivative, polyacrylate, a polyacrylate-based group, polymethylmethacrylate, a polymethylmethacrylate derivative, polystyrene, a polystyrene derivative, polyvinylalcohol, and a polyvinylalcohol derivative.

8. The photo-reactive compound of claim 1, wherein a hydrogen of one of L, V, R₁, R₂, and R₃ is substituted with F or Cl.

9. The photo-reactive compound of claim 1, wherein Formula 1 is represented by the following Formula 3 and Formula 2 is represented by the following Formula 4:

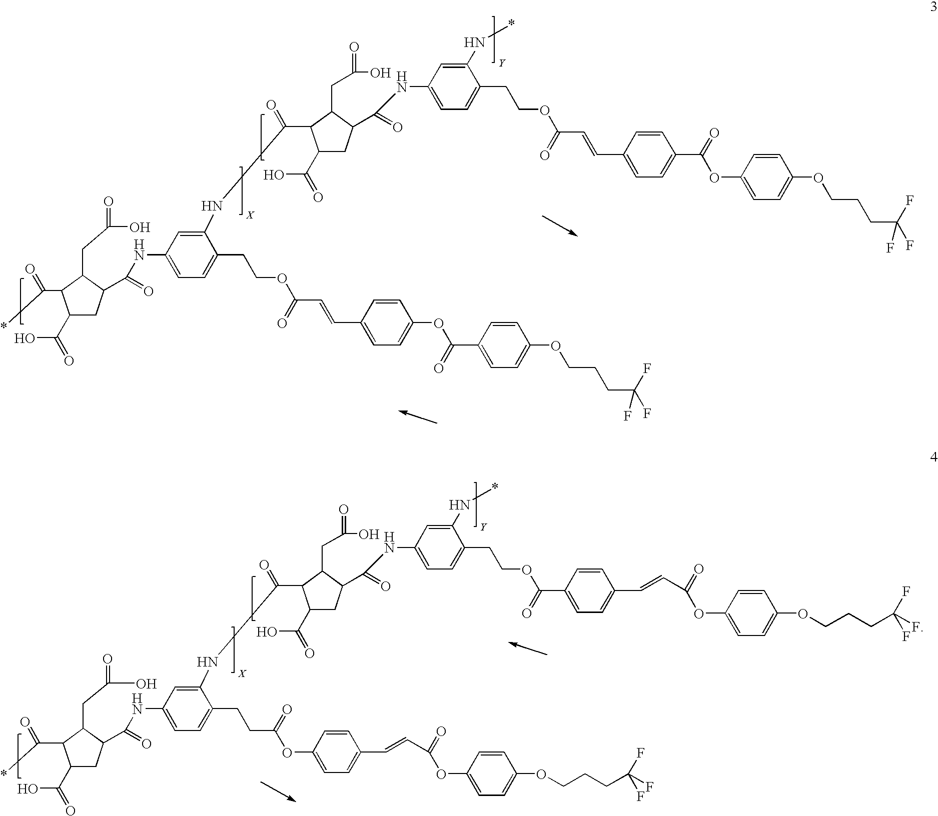

10. A liquid crystal display (LCD) device, comprising:
a lower substrate,
a thin film transistor disposed on the lower substrate,
a pixel electrode connected to the thin film transistor,
a upper substrate facing the lower substrate,
a color filter disposed on the upper substrate,
a common electrode arranged on the color filter, the common electrode facing the pixel electrode,
a liquid crystal layer disposed between the lower substrate and the upper substrate and
a photo-alignment layer supporting the liquid crystal layer, wherein the photo-alignment layer comprises a photo-reactive compound represented by the following Formula 5 or Formula 6,
wherein the photo-reactive compound is the chain combined to a polymer backbone: 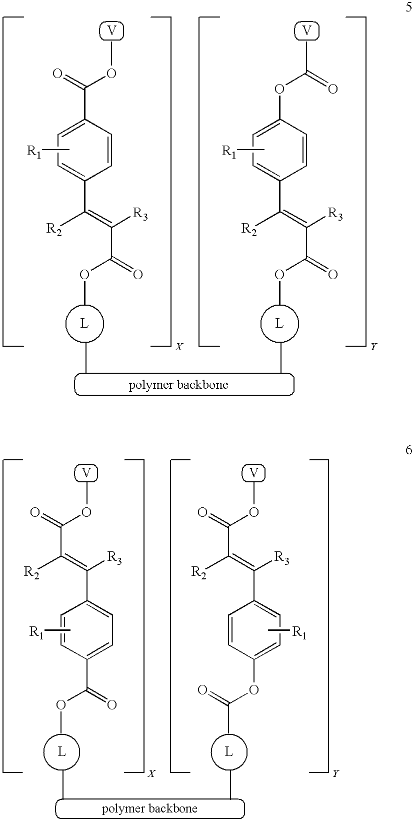
wherein L denotes a substituted or an unsubstituted alkyl group having at least 1 but no more than 18 carbons, V denotes a substituted or an unsubstituted alkyl group having at least 1 but no more than 18 carbons, R₁, R₂, and R₃ each denote H or a substituted or an unsubstituted alkyl groups having at least 1 but no more than 18 carbons, X+Y=1, 0<X, and Y<1.

11. The LCD device of claim 10, wherein Y is within a range of 0.3≦Y≦0.7.

12. The LCD device of claim 10, wherein X:Y is 1:1.

13. The LCD device of claim 10, wherein at least one carbon in L is substituted with one selected from a group consisting of O, C═O, O(C═O), benzene, a benzene derivative, cyclohexane, and a cyclohexane derivative.

14. The LCD device of claim 10, wherein at least one carbon in V is substituted with one selected from a group consisting of O, C═O, O(C═O), benzene, a benzene derivative, cyclohexane, and a cyclohexane derivative.

15. The LCD device of claim 10, wherein each of R₁, R₂, and R₃ comprises at least one carbon substituted with O, C═O, O(C═O), benzene, a benzene derivative, cyclohexane, and a cyclohexane derivative.

16. The LCD device of claim 10, wherein the polymer backbone of Formula 5 or Formula 6 is selected from a group consisting of polyimide, a polyimide derivative, polyacrylate, a polyacrylate-based group, polymethylmethacrylate, a polymethylmethacrylate derivative, polystyrene, a polystyrene derivative, polyvinylalcohol, and a polyvinylalcohol derivative.

17. The LCD device of claim 10, wherein a hydrogen of one of L, V, R₁, R₂, and R₃ is substituted with F or Cl.

18. The LCD device of claim 10, wherein Formula 5 is represented by the following Formula 7 and Formula 6 is represented by the following Formula 8: 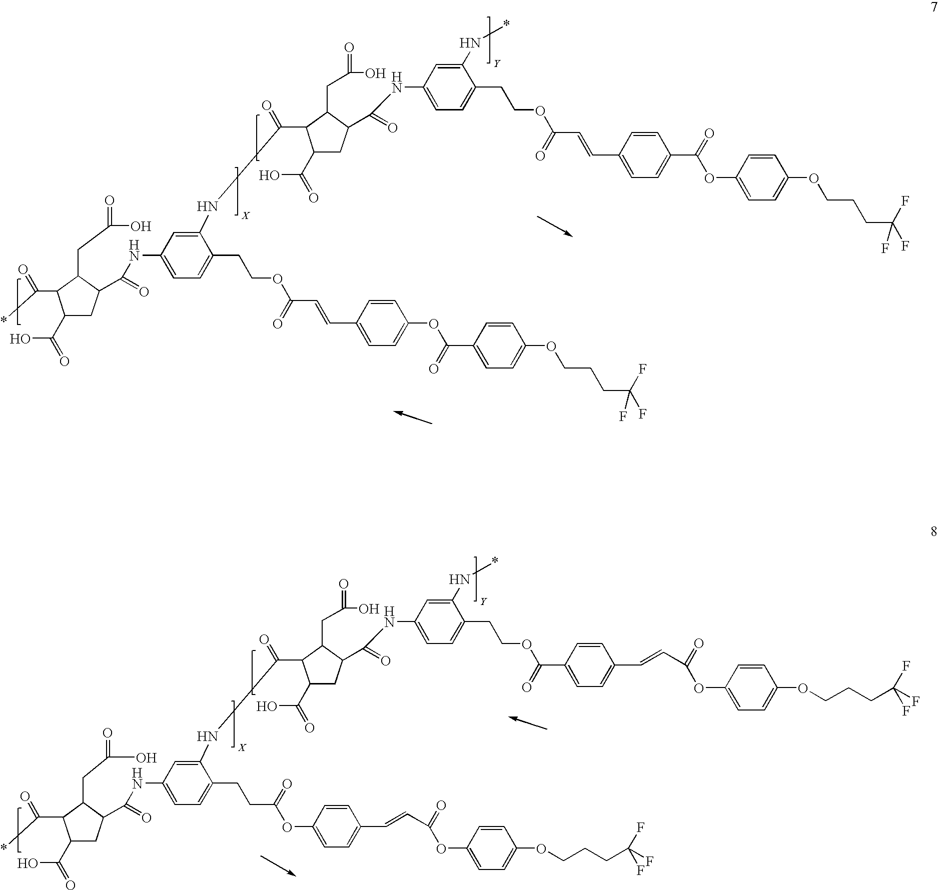
(in Formula 7 or in Formula 8, X and Y fulfill the formula X+Y=1 according to mole fraction, and X and Y respectively fulfill 0<X and Y<1).

19. A method for manufacturing liquid crystal display (LCD) device, comprising:
manufacturing a liquid crystal alignment solution by dissolving a photo-reactive compound represented by the following Formula 9 or Formula 10 in an organic solvent;
coating the liquid crystal alignment solution over a substrate and removing the solvent; and
light-radiating a surface of the solvent-removed substrate: 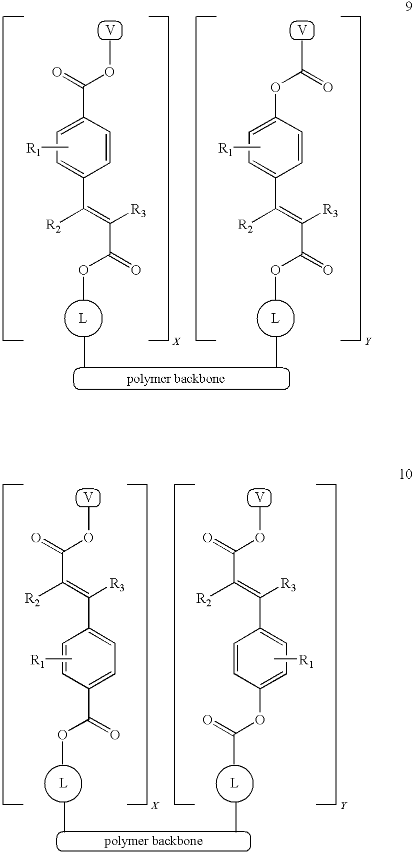
wherein L denotes a substituted or unsubstituted alkyl group having at least 1 but no more than 18 carbons, V denotes a substituted or unsubstituted alkyl group having at least 1 but no more than 18 carbons, R₁, R₂, and R₃ each denote H or a substituted or unsubstituted alkyl group having at least 1 but no more than 18 carbons, X+Y=1, 0<X, and Y<1.

20. A photo-reactive compound manufacturing method, comprising:
generating a Compound b through the following Reaction Equation M;
generating a Compound d through the following Reaction Equation N;
dissolving Compound b and Compound d in an organic solvent; and
mixing dianhydride into the mixed organic solvent, 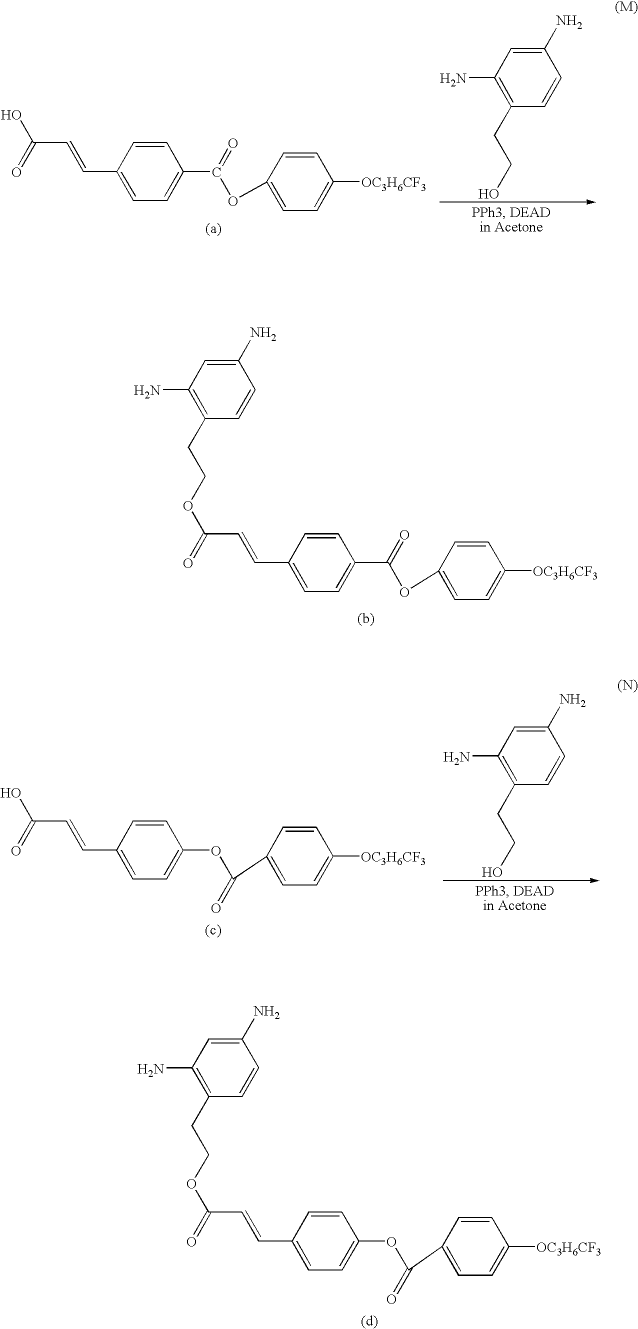
wherein PPh₃ denotes triphenylphosphine and DEAD denotes diethyl azodicarboxylate.

21. The method of claim 20, wherein a mole fraction ratio of Compound b to Compound d is 1:1.

22. The method of claim 20, wherein the organic solvent is made by mixing N-methyl pyrrolidone (NMP) and butyl cellulose (BC) at a mole fraction ratio of 7:3.
